(19) United States
(12) Patent Application Publication
(10) Pub. No.: US 2008/0121219 A1
(43) Pub. Date: May 29, 2008

(54) Emission control device for high temperature gas flow

(75) Inventor: Russell Miles Modien, Chatham (CA)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens VDO Automotive Canada Inc., Chatham (CA)

(21) Appl. No.: 11/984,356

(22) Filed: Nov. 16, 2007

Related U.S. Application Data
(60) Provisional application No. 60/867,275, filed on Nov. 27, 2006.

(51) Int. Cl. F02M 25/07; F02B 47/08

(52) U.S. Cl. 123/568.11

(57) ABSTRACT

An exhaust gas device (10) for a vehicle includes an aluminum housing (12) having at least one surface (14) defining an exhaust gas flow path (15) that is constructed and arranged to be exposed to exhaust gas of a vehicle. Temperature resistant structure (16) is provided on the surface. The temperature resistant structure has a resistance to temperature greater than that of the aluminum housing.

This application claims the benefit of the earlier filing date of U.S. Provisional Application No. 60/867,275, filed on Nov. 27, 2006, which is incorporated by reference herein in its entirety.

### FIELD OF THE INVENTION

The present invention relates to automotive devices exposed to exhaust gases and, more particularly, to a high temperature resistant exhaust gas recirculation (EGR) valve for diesel engine vehicles.

### BACKGROUND OF THE INVENTION

Tightening emissions legislation is driving the need for higher EGR flow rates with improved control. Current and past emission legislations have caused an EGR cooler of an EGR system for diesel engines to be placed typically before the EGR valve. This configuration results in excessive fouling and sooting in the EGR valve due to the cooler EGR gas temperatures. This fouling detracts from the controllability of the EGR valve. By placing the EGR valve in front of the cooler, the fouling is reduced and controllability is maintained. This hot-side placement along with higher EGR flow rates means the EGR valve will encounter higher temperatures than an aluminum housing thereof can withstand. Aluminum housings are preferred for the EGR valve due to their lower mass, lower cost, and higher flexibility in casting and machining, when compared with stainless steel housings. Currently, high temperature resistance is achieved with an iron or stainless steel casting as the housing for hot-side placed EGR valves. Liquid cooling is typically used to protect the housing, if aluminum, and the electric actuator (motor, gear train, and electronics).

There is a need to provide an aluminum EGR housing with high temperature resistance.

### SUMMARY OF THE INVENTION

An object of the invention is to fulfill the need referred to above. In accordance with the principles of an embodiment of the present invention, an exhaust gas device for a vehicle includes an aluminum housing having at least one surface defining an exhaust gas flow path that is constructed and arranged to be exposed to exhaust gas of a vehicle. Temperature resistant structure is provided on the surface. The temperature resistant structure has a resistance to temperature greater than that of the aluminum housing.

In accordance with another aspect of the invention, an exhaust gas device for a vehicle includes an aluminum housing having at least one surface defining an exhaust gas flow path that is constructed and arranged to be exposed to exhaust gas of a vehicle. Means, provided on the surface, reduce exposure of the housing to heat when the device is exposed to the exhaust gas.

In accordance with yet another aspect of the invention, a method is provided for reducing heat exposure of an aluminum housing of an exhaust gas device for a vehicle. The method provides an aluminum housing having at least one surface defining an exhaust gas flow path that is constructed and arranged to be exposed to exhaust gas of a vehicle. The method covers the at least one surface with temperature resistant structure having a resistance to temperature greater than that of the aluminum housing.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings, wherein like reference numerals refer to like parts, in which:

FIG. 1 is an exploded view of an EGR valve having an aluminum housing and temperature resistant structure provided in accordance with an embodiment of the invention.

FIG. 2 shows a thermal gradient of the temperature resistant structure and aluminum housing of an EGR valve according to an embodiment of the invention.

FIG. 3 shows a comparison of the temperature drop across an inside wall of an EGR valve with and without the temperature resistant structure of an embodiment of the invention.

### DETAILED DESCRIPTION OF THE EXEMPLARY EMBODIMENTS

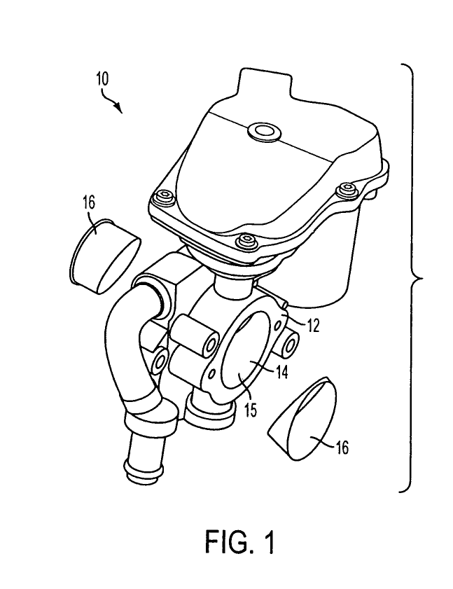

With reference to FIG. 1, an EGR valve is shown, generally indicated at 10, in accordance with the principles of an embodiment of the invention. The EGR valve 10 is conventional and includes a valve member (not shown) that regulates the flow of exhaust gas from an inlet to an outlet of the EGR valve. The EGR valve 10 includes an aluminum housing 12 having at least one surface 14 defining an exhaust gas flow path 15 that is constructed and arranged to be coupled between an exhaust gas supply (not shown) and an intake manifold of a vehicle. The housing 12 is aluminum due to its lower mass, lower cost, and higher flexibility in casting and machining, when compared with stainless steel housings.

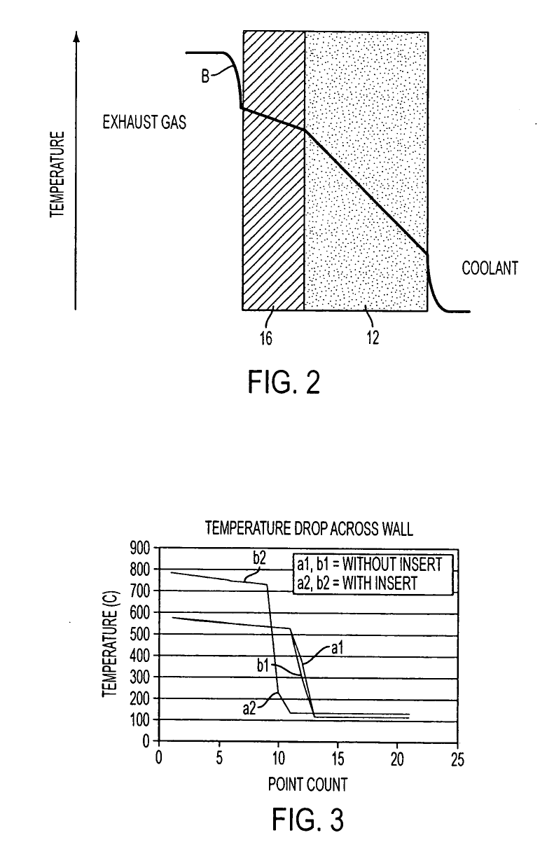

In accordance with the embodiment and shown in the exploded view of FIG. 1, the temperature resistance structure 16 is provided on the surface 14. In the embodiment, the temperature resistant structure 16 uses material with a high temperature resistance on the surface 14 of the exhaust gas flow path 15 permitting the use of aluminum for the bulk of the housing 12. The temperature resistant structure 16 may be one or more inserted components (e.g., a stainless steel sleeve or insert as in FIG. 1) or an applied coating (e.g., ceramic/metal alloy as in FIG. 2). Thus, the temperature resistant structure 16 has a resistance to temperature greater than that of the aluminum housing 12.

The housing 12 is preferably cooled with engine coolant (e.g., water and glycol mixture) which controls the temperature over the bulk of the housing 12. With the incorporation of stainless steel inserts 16, the surface 14 of the gas flow path 15 is protected from high exhaust gas temperatures and from corrosion.

With reference to FIG. 2, the insert or coating 16 is just thick enough to reduce the temperature to an acceptable level for the aluminum housing. FIG. 2 shows that a boundary layer B helps reduce the temperature at the coating 16.

With reference to FIG. 3, modeling has shown that the temperature drops quickly within the housing 12, so the insert or coating 16 can be relatively thin. Modeling has also shown that high temperatures are only at wall of surface 14 and that there are no noticeable differences with regard to performance between a housing 12 with the inserts 16 and a housing without the inserts 16. It has been found that the inset 16 spread heat along a larger surface area of the housing than in a housing without the inserts. The inserts 16 also spread out hot spots for improved cooling.

Although the temperature resistant structure 16 has been shown for use in an EGR valve, the temperature resistant structure 16 can be used to cover surfaces of other valves exposed to high temperatures such as an exhaust bypass valve (EBV).

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

What is claimed is:

1. An exhaust gas device for a vehicle comprising:
an aluminum housing having at least one surface defining an exhaust gas flow path that is constructed and arranged to be exposed to exhaust gas of a vehicle, and
temperature resistant structure provided on the surface, the temperature resistant structure having a resistance to temperature greater than that of the aluminum housing.

2. The device of claim 1, wherein the housing is a housing of an exhaust gas recirculation valve.

3. The device of claim 1, wherein the temperature resistant structure comprises at least one insert, separate from the housing that covers the surface.

4. The device of claim 3, wherein the insert is made of steel.

5. The device of claim 3, wherein the steel is stainless steel.

6. The device of claim 1, wherein the temperature resistant structure comprises a coating on the surface.

7. The device of claim 6, wherein the coating is ceramic coating.

8. The device of claim 6, wherein the coating is a metal alloy coating.

9. An exhaust gas device for a vehicle comprising:
an aluminum housing having at least one surface defining an exhaust gas flow path that is constructed and arranged to be exposed to exhaust gas of a vehicle, and
means, provided on the surface, for reducing exposure of the housing to heat when the device is exposed to the exhaust gas.

10. The device of claim 9, wherein the housing is a housing of an exhaust gas recirculation valve.

11. The device of claim 9, wherein the means for reducing comprises at least one insert, separate from the housing, that covers the surface.

12. The device of claim 11, wherein the insert is made of stainless steel.

13. The device of claim 9, wherein the means for reducing comprises a coating on the surface.

14. The device of claim 13, wherein the coating is one of a ceramic coating and a metal alloy coating.

15. A method of reducing heat exposure of an aluminum housing of an exhaust gas device for a vehicle, the method comprising:
providing an aluminum housing having at least one surface defining an exhaust gas flow path that is constructed and arranged to be exposed to exhaust gas of a vehicle,
covering the at least one surface with temperature resistant structure having a resistance to temperature greater than that of the aluminum housing.

16. The method of claim 15, wherein the covering step includes providing an insert as the temperature resistant structure.

17. The method of claim 16, wherein the inset is made of stainless steel.

18. The method of claim 15, wherein the covering step includes providing a coating as the temperature resistant structure.

19. The method of claim 18, wherein the coating is one of a ceramic coating and a metal alloy coating.

20. The method of claim 15, wherein the providing step includes providing the housing as part of an exhaust gas recirculation valve.
